(19) United States
(12) Patent Application Publication
(10) Pub. No.: US 2025/0360615 A1
(43) Pub. Date: Nov. 27, 2025

(54) ROBOT TEACHING DEVICE

(71) Applicant: Hitachi High-Tech Corporation, Tokyo (JP)

(72) Inventors: Yoshiki KANAI, Tokyo (JP); Hiroki TAKAHASHI, Tokyo (JP); Masahiro KOYAMA, Tokyo (JP); Shinichi ISHIKAWA, Tokyo (JP)

(21) Appl. No.: 19/174,148

(22) Filed: Apr. 9, 2025

(30) Foreign Application Priority Data
May 21, 2024 (JP) 2024-082283

(51) Int. Cl. B25J 9/16; B25J 9/00; B25J 13/08; B25J 15/02

(52) U.S. Cl. CPC B25J 9/163; B25J 9/0009; B25J 13/085; B25J 15/0253

(57) ABSTRACT

Provided is a robot teaching device including an end effector that can be intuitively operated by a teacher, and the robot teaching device can accurately measure an interaction force between the end effector and a work object.

In a robot teaching device 5 including a first end effector 1 that is gripped and operated by a teacher, the first end effector 1 includes a first claw portion 10 capable of switching between an openable and closable state and an opening-closing fixing state, a handle 12, and a first force sensor 11 that measures a force and torque between the first claw portion 10 and the handle 12, and generates teaching data based on an output of the first force sensor 11 when the first claw portion 10 is in the opening-closing fixing state and the handle 12 is gripped by the teacher.

### TECHNICAL FIELD

The present invention relates to a robot teaching device for teaching a predetermined work to a robot.

### BACKGROUND ART

As a robot teaching device that teaches a predetermined work to a robot, a system that causes the robot to reproduce the work performed by a teacher using a teaching device is known. Position and posture information and force and torque information of the teaching device are acquired by sensors and are used for calculation of an operation command to the robot.

PTL 1 discloses a hand mechanism that is held by a teacher and capable of opening and closing a plurality of fingers gripping an operation target. The hand mechanism includes a tactile sensor and can measure a gripping force of the operation target.

In PTL 2, a robot is controlled using data when a worker performs a predetermined work using a teaching device equipped with a force sensor.

### CITATION LIST

### Patent Literature

PTL 1: JP2022-66085A
PTL 2: JPH09-47989A

### SUMMARY OF INVENTION

### Technical Problem

However, in a technique disclosed in PTL 1, although the teacher can perform robot teaching by an intuitive operation, a sensor for measuring an interaction force with a work object is not mounted, and thus there is a problem that it is not possible to teach a work, such as a deburring work, requiring force adjustment between the robot and the work object.

In a technique disclosed in PTL 2, although an interaction force with a work object can be measured, it is necessary to develop, according to work contents, the teaching device simulating a work tool or the like handled by the robot, and thus there is a problem that engineering cost increases.

Although a configuration, in which a force sensor that measures the interaction force with the work object is mounted on the teaching device as disclosed in PTL 1, is conceivable, there is a problem that the interaction force with the work object cannot be correctly measured depending on a location where the teacher supports the teaching device and an attachment position of the force sensor.

The invention has been made in view of the above problems, an object of the invention is to provide a robot teaching device that includes an operation device intuitively operated by a teacher and can accurately measure an interaction force between the operation device and a work object.

### Solution to Problem

In order to solve the above problems, a robot teaching device according to the invention includes: a first end effector gripped and operated by a teacher; a second end effector connected to a robot; and a teaching data generation unit configured to generate teaching data for teaching the robot an operation of the second end effector based on an operation of the first end effector. The first end effector includes: a first claw portion that is switchable, by an operation of the teacher, between an openable and closable state in which the first claw portion is openable and closable and an opening-closing fixing state in which the first claw portion is not openable and closable; a handle that is capable of gripping by the teacher; and a first force sensor that is disposed between the first claw portion and the handle and that is capable of measuring a force and torque acting between the first claw portion and the handle. The teaching data generation unit generates the teaching data based on an output of the first force sensor when the first claw portion is in the opening-closing fixing state and the handle is gripped by the teacher.

### Advantageous Effects of Invention

According to the invention, a first end effector that can be intuitively operated by a teacher can be implemented by a configuration of a first claw portion in an openable and closable state and a handle. It is possible to provide a robot teaching device that can accurately measure an interaction force between the first end effector and a work object by using an output of the first force sensor when the first claw portion is in the opening-closing fixing state and the teacher grips only the handle.

Problems, configurations, and effects other than those described above will become apparent by description of the following embodiments.

### BRIEF DESCRIPTION OF DRAWINGS

FIG. 1 is a diagram showing a detailed configuration of a first end effector according to a first embodiment.

FIG. 2A is a diagram showing an image in which a teacher operates the first end effector when a first claw portion is in an openable and closable state according to the first embodiment.

FIG. 2B is a diagram showing an image in which the teacher operates the first end effector when the first claw portion is in an opening-closing fixing state according to the first embodiment.

FIG. 3 is a diagram showing control for a robot equipped with a second end effector according to the first embodiment.

FIG. 4 is a diagram showing the control for the robot by using coordinate system calibration that uses a calibration jig and a conversion matrix obtained by the calibration according to the first embodiment.

FIG. 5A is a diagram showing details of a first coordinate system calibration unit according to the first embodiment.

FIG. 5B is a diagram showing details of a second coordinate system calibration unit according to the first embodiment.

FIG. 6 is a diagram showing a coordinate system related to calculation of a force conversion matrix according to the first embodiment.

FIG. 7A is a diagram showing an image of a reference coordinate system according to the first embodiment.

FIG. 7B is a diagram showing a reference coordinate system setting unit according to the first embodiment.

FIG. 8 is a diagram showing details of a robot control unit according to the first embodiment.

FIG. 9 is a diagram showing a coordinate system related to calculation of a force conversion matrix according to a second embodiment.

### DESCRIPTION OF EMBODIMENTS

Hereinafter, an embodiment will be described with reference to the drawings. Although the drawings show embodiments and examples according to a principle of the disclosure, the drawings are for understanding the disclosure and are not intended to interpret the disclosure in a limited manner. The description of the present specification is merely a typical example and does not limit the scope of claims or application examples of the disclosure in any sense.

Hereafter, embodiments are described in sufficient details for those skilled in the art to implement the disclosure, but other implementations and aspects are possible, and changes in configurations and structures and replacement of various elements are possible without departing from the scope of the technical idea of the disclosure.

In the following description, when there are a plurality of identical or corresponding components, an alphabet may be added to the end of a reference sign (number), but the plurality of components may be collectively denoted by omitting the alphabet. For example, when two first claw portions 10a and 10b or two second claw portions 20a and 20b are present, they may be collectively referred to as a first claw portion 10 and a second claw portion 20.

### First Embodiment

A configuration of a robot teaching device 5 according to a first embodiment of the invention will be described. The robot teaching device 5 in the embodiment mainly includes a first end effector 1 gripped and operated by a teacher, a second end effector 2 connected to a robot 22, a teaching data generation unit 25 that generates teaching data 24 for controlling the robot 22, and a robot control unit 23 that controls the robot 22 using the teaching data 24.

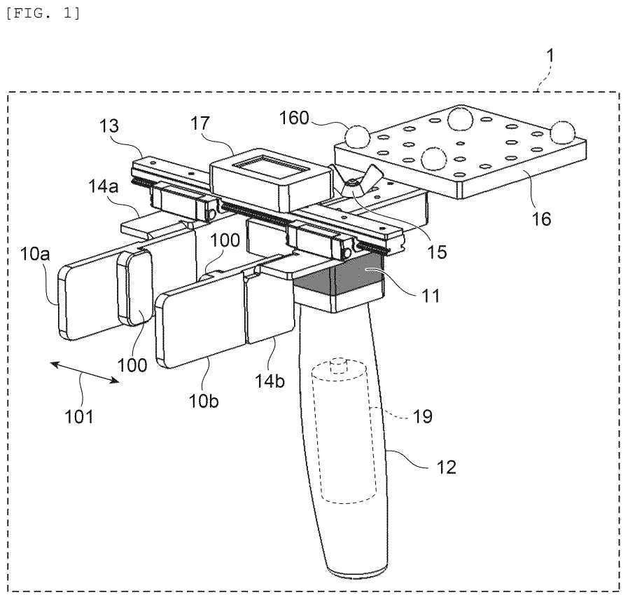

FIG. 1 is a diagram showing a detailed configuration of the first end effector according to the first embodiment. The first end effector 1 includes a pair of the first claw portions 10a and 10b, a handle 12 that can be gripped by the teacher, and a first force sensor 11 that is disposed between the first claw portion 10 and the handle 12 and that can measure force and torque information (information on at least one of a force or a torque: the same applies hereinafter) acting between the first claw portion 10 and the handle 12.

The first claw portions 10a and 10b in the embodiment move in parallel in a first claw portion opening and closing direction 101 by a guide such as an opening and closing mechanism 13, and the first claw portions 10a and 10b move (open and close) symmetrically by a parallel mechanism (not shown).

The first claw portions 10a and 10b are connected to the opening and closing mechanism 13 via opening and closing operation units 14a and 14b, and the teacher can manually open and close the first claw portion 10 by pressing an opening and closing operation unit 14 to perform an opening and closing operation of the opening and closing mechanism 13. Each of the first claw portions 10a and 10b has a first claw portion gripping structure 100 (hereinafter, may be simply referred to as a gripping structure 100).

The opening and closing operation unit 14 may be mounted on the handle 12. For example, the opening and closing operation unit 14 may have a lever shape, and the opening and closing operation unit 14 and the first claw portion 10 may be connected to each other by a wire (not shown). When the opening and closing operation unit 14 is operated, a power may be used to open and close the first claw portion 10 via the wire.

The first end effector 1 may include an electric actuator (not shown), and the electric actuator may be connected to the first claw portion 10. When the opening and closing operation unit 14 is operated, the electric actuator may be driven to open and close the first claw portion 10.

When an opening-closing fixing mechanism 15 is operated, an opening and closing state of the opening and closing mechanism 13 is fixed, the first claw portion 10 is fixed at a position, and the first claw portion 10 does not move (does not open and close) even when the opening and closing operation unit 14 is operated. In the example of FIG. 1, the opening-closing fixing mechanism 15 has a screw shape and is connected to the opening and closing operation units 14a and 14b by links (not shown). When a screw is tightened, the first claw portion 10 enters an opening-closing fixing state in which the first claw portion 10 cannot be opened and closed. When the screw is loosened, the opening-closing fixing mechanism 15 can slide in a direction orthogonal to the first claw portion opening and closing direction 101, and the first claw portion 10 enters an openable and closable state in which the first claw portion 10 can be opened and closed by an operation of the teacher. As described above, in the embodiment, by an operation of the opening-closing fixing mechanism 15, the first claw portion 10 can be switched, by the operation of the teacher, between the openable and closable state in which the first claw portion 10 can be opened and closed and the opening-closing fixing state in which the first claw portion 10 cannot be opened and closed.

A position and posture (at least one of a position or a posture: the same applies hereinafter) of a first to-be-measured unit 16 is measured by a position and posture measurement unit 31 to be described later. The position and posture measurement unit 31 is, for example, an infrared camera, recognizes a plurality of optical markers 160 provided on the first to-be-measured unit 16, and recognizes an object by an arrangement pattern of the plurality of optical markers 160.

An information processing unit 17 manages output information of the sensor mounted on the first end effector 1 and transmits the information to an external processing device (external device). In the example of FIG. 1, the information processing unit 17 receives force and torque information that is an output of the first force sensor 11, and transmits the information to an external processing device using a wireless communication method. By adopting the wireless communication method, the number of signal wirings connected to the first end effector 1 can be reduced, and the robot teaching device can be expected to be easily handled by the teacher.

A battery 19 is built in, for example, the handle 12 or the information processing unit 17, and supplies a power to the first force sensor 11 and the information processing unit 17. By mounting the battery 19, the number of power supply wirings connected to the first end effector 1 can be reduced, and the robot teaching device can be expected to be easily handled by the teacher.

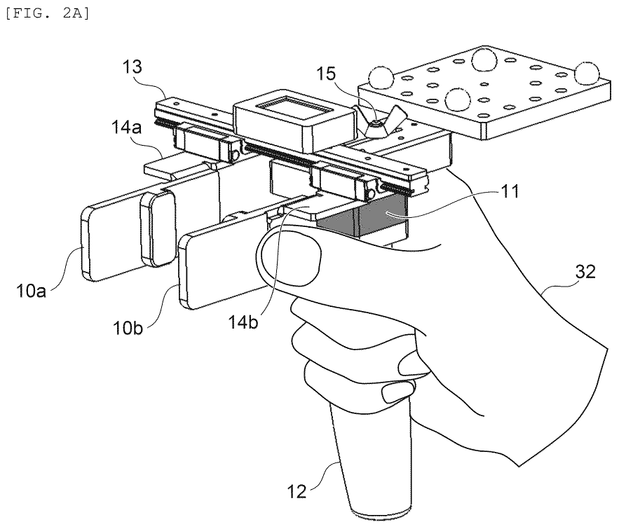

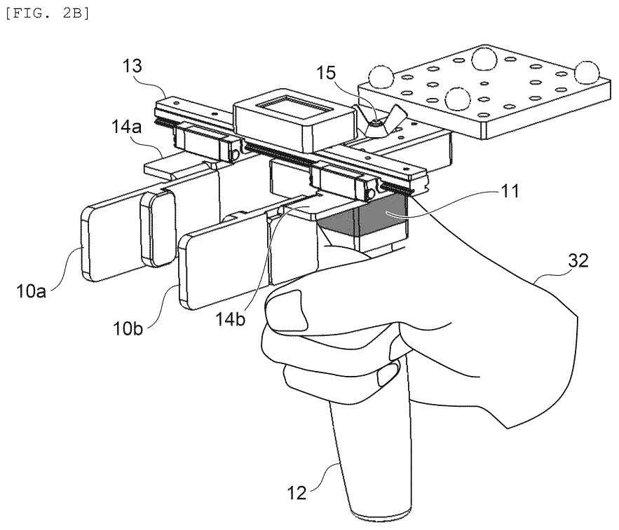

FIG. 2A is a diagram showing an image in which a teacher 32 operates the first end effector 1 when the first claw portion 10 is in the openable and closable state according to the first embodiment. In the example shown in FIG. 2A, the teacher 32 performs the opening and closing operation of the first claw portion 10 by operating the opening and closing operation unit 14b with the thumb and operating the opening and closing operation unit 14a with the index finger.

FIG. 2B is a diagram showing an image in which the teacher 32 operates the first end effector 1 when the first claw portion 10 is in the opening-closing fixing state according to the first embodiment. In the example shown in FIG. 2B, the position of the first claw portion 10 is fixed by screwing the opening-closing fixing mechanism 15. The teacher 32 grips only the handle 12 and performs a desired work.

As shown in FIG. 2A, when the teacher 32 performs a desired work in a state of touching the opening and closing operation unit 14, for example, an interaction force with an external environment applied to the first claw portion 10 is supported by a part of the hand of the teacher 32, and thus it is difficult to accurately measure an interaction force by the first force sensor 11. Therefore, as shown in FIG. 2B, it is desirable to acquire the output (a measured value of the force and torque) of the first force sensor 11 in a state in which the first claw portion 10 is in the opening-closing fixing state and the teacher 32 grips only the handle 12.

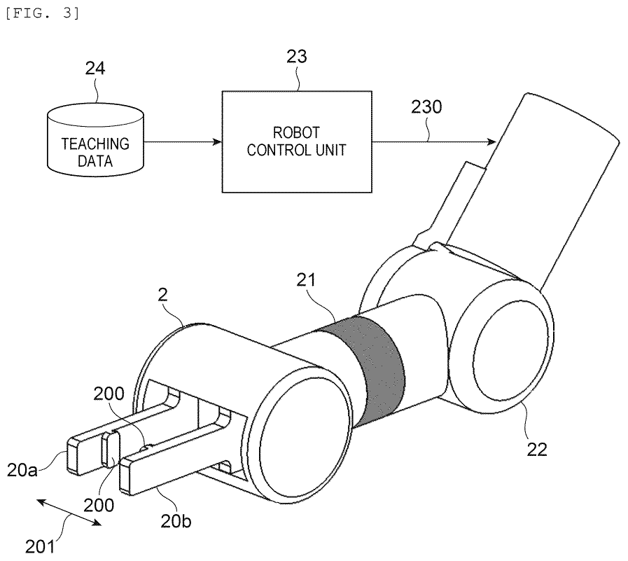

FIG. 3 is a diagram showing control for the robot 22 equipped with the second end effector 2 according to the first embodiment. The robot 22 includes a plurality of actuators (not shown). By controlling positions or forces thereof, it is possible to control a position or a force of the second end effector 2 mounted on a tip end of the robot 22.

The second end effector 2 is connected to the robot 22 via a second force sensor 21. The second force sensor 21 is disposed between the second end effector 2 and the robot 22 and can measure a force and torque between the second end effector 2 and the robot 22. A pair of the second claw portions 20a and 20b are connected to a tip end of the second end effector 2, and the second claw portions 20a and 20b can be opened and closed in a second claw portion opening and closing direction 201 by a power from the robot 22. Each of the second claw portions 20a and 20b includes a second claw portion gripping structure 200 (hereinafter, may be simply referred to as a gripping structure 200) having at least partially the same structure as the gripping structure 100 of the first claw portion 10.

A flow of control for the robot 22 will be described. First, the teaching data 24 is generated based on the position and posture information of the first end effector 1 of the position and posture measurement unit 31 and the force and torque information of the first force sensor 11, which are obtained when a desired work is performed using the first end effector 1. The teaching data 24 is data for controlling the robot 22. The teaching data 24 in the embodiment is data for teaching an operation of the second end effector 2 of the robot 22. The teaching data 24 is input to the robot control unit 23, and a robot control command 230 is transmitted from the robot control unit 23 to the robot 22 based on information included in the teaching data 24 to drive the robot 22. The robot control command 230 is, for example, a hand position or a hand velocity of the robot 22, and a joint position, a joint velocity, or a joint torque of the robot 22.

A specific flow from teaching to an operation of the robot 22 will be described.

As an example, a work of removing burrs of a workpiece is considered. First, in a teaching procedure, the teacher grips the first end effector 1 as shown in FIG. 2A to open and close the first claw portion 10, grips a tool for deburring work by the first claw portion gripping structure 100, fixes the position of the first claw portion 10 by the opening-closing fixing mechanism 15, and fixes a gripping state of the tool. At this time, it is desirable to restrict a position and posture relation between the first end effector 1 and the tool. The teacher grips the handle 12 and brings the tool fixed to the first end effector 1 into contact with the workpiece to perform the deburring work. Here, since the teacher grips only the handle 12, the first force sensor 11 can accurately measure a reaction force received by the tool from the workpiece, that is, force information necessary for performing the deburring work. The teacher acquires the position and posture information of the first end effector 1 of the position and posture measurement unit 31 during the deburring work and the force and torque information of the first force sensor 11 at constant time intervals (for example, once every 0.1 seconds), and arranges the information in time series as the teaching data 24. When the robot 22 is controlled using the teaching data 24 such that the positions and postures of the first end effector 1 and the second end effector 2 and the forces and torques of the first force sensor 11 and the second force sensor 21 coincide with each other, a desired deburring work is implemented by the robot 22.

In the above example, when the configurations of the first end effector 1 and the second end effector 2 (for example, dimensions and arrangement position of force sensor) are completely the same, the teaching data 24 can be used for robot control without being particularly corrected. However, for example, when a machine difference (for example, assembly accuracy and processing accuracy of a member) occurs between the first end effector 1 and the second end effector 2, there is a possibility that a desired deburring work is not reproduced with the data as it is. Therefore, in order to compensate for the machine difference between the first end effector 1 and the second end effector 2, it is necessary to calibrate each measurement coordinate system.

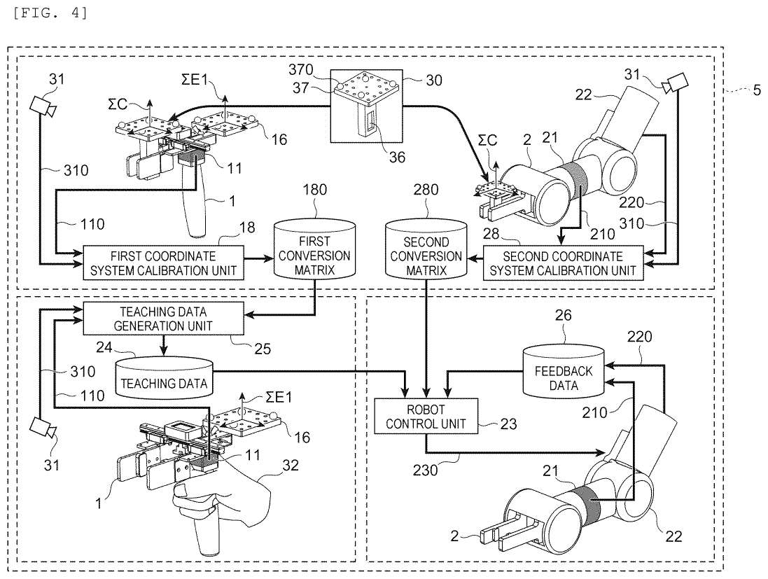

FIG. 4 is a diagram showing the control for the robot 22 by using coordinate system calibration that uses a calibration jig 30 and conversion matrixes 180 and 280 obtained by the calibration according to the first embodiment.

Since the first end effector 1 and the second end effector 2 are devised to be easily gripped by the teacher 32, configurations such as a measurement reference position of each end effector and an attachment position of the force sensor may be different. Therefore, when each coordinate system is not correctly calibrated, correct control is not performed.

In view of the above problem, in the embodiment, each coordinate system is calibrated using the calibration jig 30.

The calibration jig 30 includes a to-be-gripped structure 36 that uniquely determines a position and posture of the calibration jig 30 with respect to each end effector when the calibration jig 30 is gripped by the gripping structures 100 and 200 of the first and second claw portions of the first and second end effectors.

For example, with respect to protrusion shapes of the gripping structures 100 and 200, the to-be-gripped structure 36 has a recessed shape that is accurately fitted to the protrusion shape, and the position and posture of the calibration jig 30 are uniquely determined with respect to each end effector by the fitting thereof and a gripping force.

A position and posture of a third to-be-measured unit 37 is measured by the position and posture measurement unit 31 to be described later. The position and posture measurement unit 31 (for example, an infrared camera) recognizes a plurality of optical markers 370 provided on the third to-be-measured unit 37, and recognizes an object by an arrangement pattern of the plurality of optical markers 370.

First, calibration of the first end effector 1 will be described.

The first end effector 1 in a state in which the calibration jig 30 is gripped by the first claw portion 10 is measured using the position and posture measurement unit 31 (for example, an infrared camera), and position and posture information 310 of the first end effector 1 measured by the position and posture measurement unit 31 and the calibration jig 30 gripped (fixed) by the first claw portion 10 (hereinafter, data output from the position and posture measurement unit 31 is indicated as position and posture measurement data 310, and information of the first end effector 1 and the calibration jig 30 is not necessarily included) and force and torque information 110 output from the first force sensor 11 (hereinafter, first force sensor data 110) (as a result of simultaneous measurement) are input to a first coordinate system calibration unit 18.

The position and posture information of the first end effector 1 measured by the position and posture measurement unit 31 is a position and posture of a first end effector coordinate system ΣE1 defined based on the first to-be-measured unit 16. The position and posture information of the calibration jig 30 gripped (fixed) by the first claw portion 10, which is measured by the position and posture measurement unit 31, is a position and posture of a calibration jig coordinate system ΣC defined based on the third to-be-measured unit 37.

The first coordinate system calibration unit 18 calculates the first conversion matrix 180 for converting the position and posture of the first end effector coordinate system ΣE1 and the force and torque information that is a measurement origin reference of the first force sensor 11 into the position and posture and the force and torque information based on any coordinate system defined in association with the calibration jig coordinate system ΣC. That is, the first coordinate system calibration unit 18 obtains the first conversion matrix 180 for converting the position and posture of the first end effector coordinate system ΣE1 (the position and posture information of the first end effector 1) and the force and torque information that is the measurement origin reference of the first force sensor 11 into data expressed by a reference coordinate system defined in association with the first claw portion gripping structure 100.

Next, calibration of the second end effector 2 will be described.

The second end effector 2 in a state in which the calibration jig 30 is gripped by the second claw portion 20 is measured using the position and posture measurement unit 31 (for example, an infrared camera), and a robot state quantity 220 (hereinafter, robot position and posture measurement data 220) acquired from the robot 22, the position and posture information of the calibration jig 30 gripped (fixed) by the second claw portion 20, which is measured by the position and posture measurement unit 31, and force and torque information 210 (hereinafter, second force sensor data 210) output from the second force sensor 21 (as a result of simultaneous measurement) are input to a second coordinate system calibration unit 28.

The robot position and posture measurement data 220 is, for example, a joint angle of the robot 22, and the hand position of the robot 22, that is, a reference position and posture of the second end effector 2 can be calculated by solving forward kinematics calculation.

The second coordinate system calibration unit 28 calculates the second conversion matrix 280 for converting the reference position and posture of the second end effector 2 and the force and torque information that is a measurement origin reference of the second force sensor 21 into the position and posture and the force and torque information based on any coordinate system defined in association with the calibration jig coordinate system ΣC. That is, the second coordinate system calibration unit 28 obtains the second conversion matrix 280 for converting the reference position and posture of the second end effector 2 (the position and posture information of the second end effector 2) and the force and torque information that is the measurement origin reference of the second force sensor 21 into data expressed by a reference coordinate system defined in association with the second claw portion gripping structure 200.

Here, the first conversion matrix 180 and the second conversion matrix 280 are calculated based on a common coordinate system defined in association with the calibration jig coordinate system ΣC.

Next, a procedure for generating the teaching data 24 using the first end effector 1 will be described.

The position and posture measurement unit 31 measures a state in which the teacher 32 grips the first end effector 1 and performs a desired work. The position and posture measurement data 310 and the first force sensor data 110 are acquired at a constant sampling period and input to the teaching data generation unit 25 as time-series data.

The teaching data generation unit 25 converts, based on the first conversion matrix 180, the position and posture measurement data 310 and the first force sensor data 110 into the position and posture and the force and torque information based on any coordinate system defined in association with the calibration jig coordinate system ΣC, and stores them as the teaching data 24. That is, the teaching data generation unit 25 converts, by the first conversion matrix 180, the position and posture measurement data 310 (the position and posture information of the first end effector 1) and the first force sensor data 110 (the force and torque information of the first force sensor 11) into the teaching data 24 on the position and posture and the force and torque expressed by the reference coordinate system defined in association with the gripping structures 100 and 200.

Finally, a procedure for controlling the robot 22 based on the teaching data 24 will be described. The robot 22 is controlled to reproduce the position and posture and the force and torque information stored in the teaching data 24.

The robot control unit 23 calculates the robot control command 230 and transmits the robot control command 230 to the robot 22 such that the position and posture and the force and torque information stored in the teaching data 24 is consistent with the data obtained by converting feedback data 26, which is based on the robot position and posture measurement data 220 that can be acquired from the robot 22 and the second force sensor data 210 that is the output of the second force sensor 21, into the position and posture and the force and torque information based on any coordinate system defined in association with the calibration jig coordinate system ΣC by using the second conversion matrix 280. That is, the robot control unit 23 converts, by the second conversion matrix 280, the robot position and posture measurement data 220 (the position and posture information of the second end effector 2) and the second force sensor data 210 (the force and torque information of the second force sensor 21) into data on the position and posture and the force and torque expressed by the reference coordinate system defined in association with the gripping structures 100 and 200, calculates the robot control command 230, and transmits the robot control command 230 to the robot 22 such that these data follow the position and posture and the force and torque information stored in the teaching data 24. By controlling the robot 22 in time series indicated by the teaching data 24, the robot 22 behaves so as to reproduce a position and a force of a work performed by the teacher 32.

Since the first conversion matrix 180 and the second conversion matrix 280 are values based on the common coordinate system defined in association with the calibration jig coordinate system ΣC, it is possible to perform control based on the common coordinate system by applying the conversion matrix to the teaching data 24 and the feedback data 26 having different reference coordinate systems, and as a result, it is possible to accurately reproduce a position and a force of a desired work.

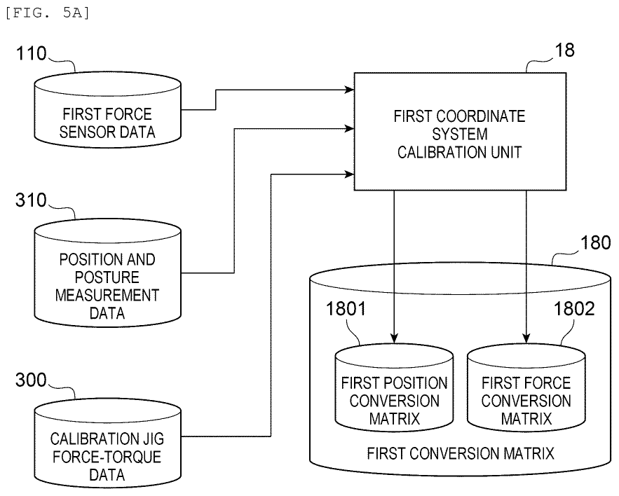

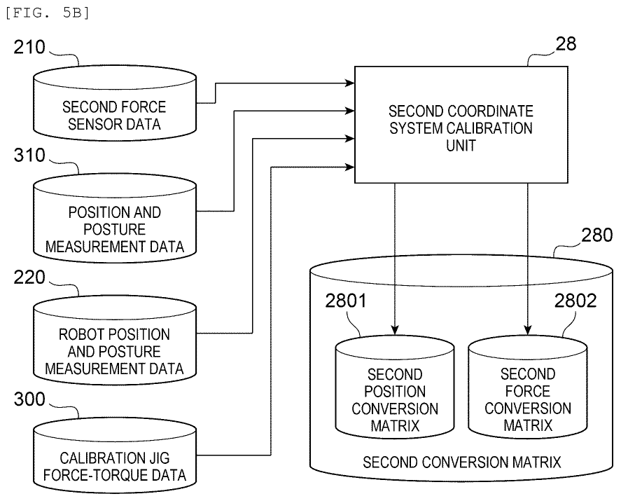

FIG. 5A is a diagram showing details of the first coordinate system calibration unit 18 according to the first embodiment.

The first coordinate system calibration unit 18 calculates the first conversion matrix 180 based on the first force sensor data 110, the position and posture measurement data 310, and calibration jig force-torque data 300 acquired by measuring or calculating the force and torque applied to the calibration jig 30.

Further, the first conversion matrix 180 includes a first position conversion matrix 1801 for converting the position and posture information and a first force conversion matrix 1802 for converting the force and torque information.

FIG. 5B is a diagram showing details of the second coordinate system calibration unit according to the first embodiment.

The second coordinate system calibration unit 28 calculates the second conversion matrix 280 based on the second force sensor data 210, the position and posture measurement data 310, the robot position and posture measurement data 220, and the calibration jig force-torque data 300 acquired by measuring or calculating the force and torque applied to the calibration jig 30.

Further, the second conversion matrix 280 includes a second position conversion matrix 2801 for converting the position and posture information and a second force conversion matrix 2802 for converting the force and torque information.

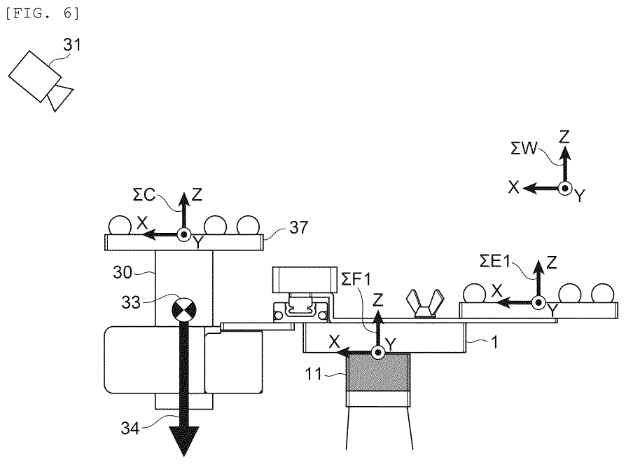

FIG. 6 is a diagram showing a coordinate system related to calculation of the first conversion matrix 180 in the first end effector 1 according to the first embodiment.

In the embodiment, it is assumed that a position and posture of a calibration jig gravity center 33 viewed from the calibration jig coordinate system ΣC of the calibration jig 30 and a calibration jig gravity 34 based on weight data of the calibration jig 30 are known, and the calibration jig gravity 34 is used as the calibration jig force-torque data 300.

The first end effector 1 in a state in which the calibration jig 30 is gripped by the first claw portion 10 is measured by the position and posture measurement unit 31. The position and posture measurement data 310 measured by the position and posture measurement unit 31 acquires position and posture information of each to-be-measured unit based on a world coordinate system ΣW. In the example of FIG. 6, the positions and postures of the calibration jig coordinate system ΣC and the first end effector coordinate system ΣE1 can be acquired, and a first force sensor coordinate system ΣF1, which is a measurement origin of the first force sensor 11, cannot be measured.

The first position conversion matrix 1801 can be directly acquired by calculating a relative position relation between the calibration jig coordinate system ΣC and the first end effector coordinate system ΣE1.

On the other hand, the first force conversion matrix 1802 cannot be directly acquired because the first force sensor coordinate system ΣF1 cannot be measured. Therefore, the first force conversion matrix 1802 is acquired by calculating the relative position relation between the calibration jig coordinate system ΣC and the first force sensor coordinate system ΣF1 by using the calibration jig force-torque data 300.

When an orientation of a gravity acceleration with respect to the world coordinate system ΣW is known (for example, a −Z-axis direction of the world coordinate system ΣW), force and torque information of the calibration jig gravity 34 viewed from the calibration jig coordinate system ΣC can be calculated based on the position and posture of the calibration jig coordinate system ΣC measured by the position and posture measurement unit 31 and the known position and posture of the calibration jig gravity center 33. In addition, the force and torque information of the calibration jig gravity 34 viewed from the first force sensor coordinate system ΣF1 can be acquired based on the output of the first force sensor 11. The relative position relation between the calibration jig coordinate system ΣC and the first force sensor coordinate system ΣF1 can be calculated based on the two pieces of force and torque information described above.

In order to improve the accuracy of the calculation, various types of information in a plurality of orientations other than the first end effector 1 shown in FIG. 6 may be used to calculate the relative position relation. At this time, it is desirable to provide a stand (not shown) that can freely fix the handle 12 to the ground.

In the second end effector 2, the second position conversion matrix 2801 and the second force conversion matrix 2802 are also calculated in the above-described procedure. The reference position and posture of the second end effector 2 may be calculated by solving the forward kinematics calculation using the joint angle of the robot 22 included in the robot position and posture measurement data 220. Similarly to the first to-be-measured unit 16, a second to-be-measured unit (not shown) is mounted on the second end effector 2, and a value, which is obtained by measuring a position and posture of the second to-be-measured unit by the position and posture measurement unit 31, may be used.

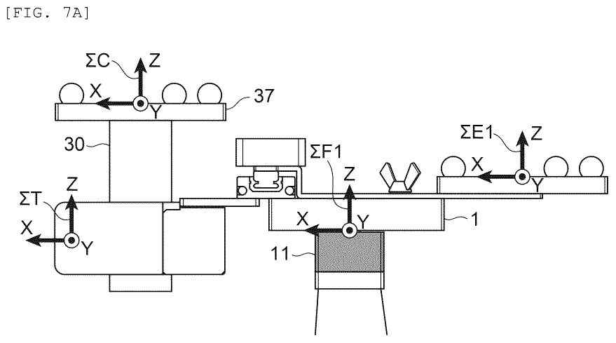

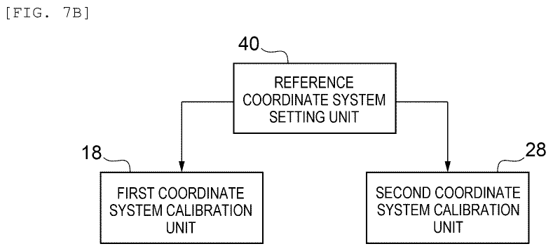

FIG. 7A is a diagram showing an image of a reference coordinate system ΣT according to the first embodiment.

The reference coordinate system ΣT is defined in association with the calibration jig coordinate system ΣC, and is set by the teacher 32 at a relative position and posture viewed from the calibration jig coordinate system ΣC. For example, a gripping center position of a claw portion, a tip end position of an object to be gripped by the claw portion, or the like is assumed.

FIG. 7B is a diagram showing a reference coordinate system setting unit 40 according to the first embodiment.

When the reference coordinate system ΣT is set by the teacher 32, information of the reference coordinate system ΣT is transmitted from the reference coordinate system setting unit 40 to the first and second coordinate system calibration units 18 and 28. The first and second coordinate system calibration units 18 and 28 calculate the first and second conversion matrixes 180 and 280 for converting the position and posture information and the force and torque information to the reference coordinate system ΣT reference based on the information of the reference coordinate system ΣT set by the reference coordinate system setting unit 40.

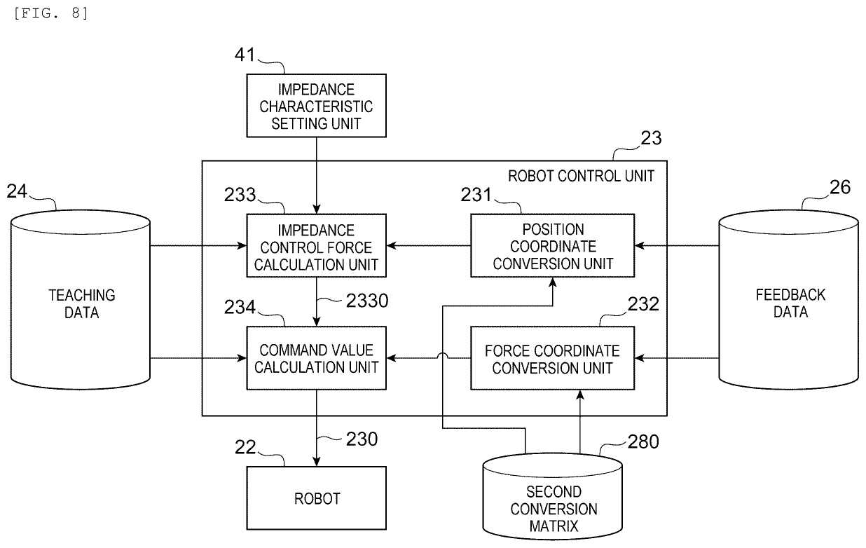

FIG. 8 is a diagram showing details of the robot control unit 23 according to the first embodiment. The robot control unit 23 in the embodiment includes a position coordinate conversion unit 231, a force coordinate conversion unit 232, an impedance control force calculation unit 233, and a command value calculation unit 234. The position and posture information of the feedback data 26 is converted into the reference coordinate system ΣT reference by the position coordinate conversion unit 231 based on the second conversion matrix 280. The force and torque information of the feedback data 26 is converted into the reference coordinate system ΣT reference by the force coordinate conversion unit 232 based on the second conversion matrix 280.

The robot control unit 23 in FIG. 8 performs impedance control such that a target impedance characteristic is set for a difference between the position and posture information of the teaching data 24 and the position and posture information of the feedback data 26 which is converted into the reference coordinate system ΣT reference (that is, the position and posture information of the second end effector 2 expressed by the reference coordinate system ΣT).

The teacher 32 sets the target impedance characteristic in advance by an impedance characteristic setting unit 41. The target impedance characteristic is, for example, a spring characteristic, a damper characteristic, and a mass characteristic.

The impedance control force calculation unit 233 calculates an impedance control force and torque 2330 based on the difference between the position and posture information in the teaching data 24 and the output of the position coordinate conversion unit 231 and based on the target impedance characteristic set by the impedance characteristic setting unit 41.

The command value calculation unit 234 calculates the robot control command 230 based on the impedance control force and torque 2330 output from the impedance control force calculation unit 233, the force and torque information in the teaching data 24, and the output of the force coordinate conversion unit 232, and transmits the robot control command 230 to the robot 22.

The robot control unit 23 described above controls the robot 22 such that the target impedance characteristic set by the teacher 32 is implemented with respect to the reference coordinate system ΣT set by the teacher 32.

According to the embodiment, first, as shown in FIG. 1, the first end effector 1 including the first claw portion 10 that can be opened and closed can perform a desired work while imaging the operation of the second end effector 2 mounted on the robot 22, and can perform intuitive robot teaching. As shown in FIG. 2B, by acquiring the output (the measured value of the force and torque) of the first force sensor 11 in a state in which the first claw portion 10 is in the opening-closing fixing state and the teacher 32 grips only the handle 12, the interaction force with the external environment applied to the first claw portion 10 can be accurately measured. Next, by using the calibration jig 30 as shown in FIG. 3, even when there is a difference in configuration between the first end effector 1 and the second end effector 2, a position and a force measured by the first end effector 1 can be accurately reproduced by the robot 22 by calibrating a position relation between the coordinate systems.

### Second Embodiment

A configuration of the robot teaching device 5 according to a second embodiment of the invention will be described. In the embodiment, differences from the first embodiment will be mainly described, and configurations not described are similar to those of the first embodiment.

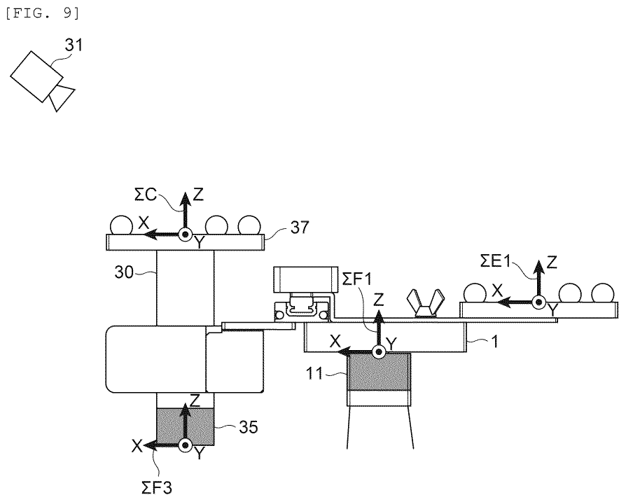

FIG. 9 is a diagram showing a coordinate system related to the calculation of the first conversion matrix 180 in the first end effector 1 according to the second embodiment.

In the embodiment, the calibration jig 30 includes a third force sensor 35, and a position relation between the calibration jig coordinate system ΣC and a third force sensor coordinate system ΣF3, which is a measurement origin of the third force sensor 35 is known.

The first end effector 1 in a state in which the calibration jig 30 is gripped by the first claw portion 10 is measured by the position and posture measurement unit 31. In the example of FIG. 9, the positions and postures of the calibration jig coordinate system ΣC and the first end effector coordinate system ΣE1 can be acquired, and the first force sensor coordinate system ΣF1 and the third force sensor coordinate system ΣF3 cannot be measured.

The first force conversion matrix 1802 cannot be directly acquired because the first force sensor coordinate system ΣF1 cannot be measured. Therefore, the first force conversion matrix 1802 is acquired by calculating the relative position relation between the calibration jig coordinate system ΣC and the first force sensor coordinate system ΣF1 by using the output of the third force sensor 35 as the calibration jig force-torque data 300.

The teacher 32 brings the first claw portion 10 of the first end effector 1 into the opening-closing fixing state, grips the handle 12, and presses the third force sensor 35 provided in the calibration jig 30 against a structure in a surrounding environment. Accordingly, the third force sensor 35 outputs force and torque information between the structure in the surrounding environment and the calibration jig 30 (that is, force and torque information applied to the calibration jig 30).

Since the position relation of the third force sensor coordinate system ΣF3 viewed from the calibration jig coordinate system ΣC is known, the force and torque information applied to the third force sensor 35 viewed from the calibration jig coordinate system ΣC can be calculated based on the output of the third force sensor 35. In addition, the force and torque information applied to the third force sensor 35 viewed from the first force sensor coordinate system ΣF1 can be acquired based on the output of the first force sensor 11. The relative position relation between the calibration jig coordinate system ΣC and the first force sensor coordinate system ΣF1 can be calculated based on the two pieces of force and torque information described above.

In order to improve the accuracy of the calculation, various types of information in a plurality of orientations other than the first end effector 1 shown in FIG. 9 may be used to calculate the relative position relation.

In the second end effector 2, the second force conversion matrix 2802 is also calculated in the above-described procedure.

According to the embodiment, the third force sensor 35 may be mounted with high accuracy in the position relation with the calibration jig coordinate system ΣC, and a nominal error factor with respect to a design value can be reduced as compared with Embodiment 1, and thus it can be expected that the second force conversion matrix 2802 is calculated with high accuracy.

### SUMMARY

As described above, the robot teaching device 5 according to the embodiment includes: the first end effector 1 gripped and operated by a teacher; the second end effector 2 connected to the robot 22; and the teaching data generation unit 25 that generates the teaching data 24 for controlling the robot 22 (for teaching the robot 22 the operation of the second end effector 2 (when performing a predetermined operation) based on the operation of the first end effector 1). The first end effector 1 includes: the first claw portion 10 is switchable, by an operation of the teacher, between an openable and closable state in which the first claw portion 10 is openable and closable and an opening-closing fixing state in which the first claw portion 10 is not openable and closable; the handle 12 that is capable of gripping by the teacher; and the first force sensor 11 that is disposed between the first claw portion 10 and the handle 12 and that is capable of measuring a force and torque acting between the first claw portion 10 and the handle 12. The teaching data generation unit 25 generates the teaching data 24 based on an output (a measured value of the force and torque) of the first force sensor 11 when the first claw portion 10 is in the opening-closing fixing state and the handle 12 is gripped by the teacher.

In addition, the robot teaching device 5 according to the embodiment includes: the second force sensor 21 that is disposed between the robot 22 and the second end effector 2 and that is capable of measuring a force and torque acting between the robot 22 and the second end effector 2; the position and posture measurement unit 31 (for example, an infrared camera) that measures a position and posture of the first end effector 1; and the robot control unit 23 that controls (the operation of the second end effector 2 of) the robot 22, based on the teaching data 24 generated by the teaching data generation unit 25 based on the output of the position and posture measurement unit 31 and the output of the first force sensor 11 and based on a position and posture of the second end effector 2 and an output of the second force sensor 21. The second end effector 2 includes the second claw portion 20 that is opened and closed by a power from the robot 22 and that has the gripping structure 200 at least partially same as the gripping structure 100 of the first claw portion 10.

The robot teaching device 5 according to the embodiment includes: the calibration jig 30 fixed such that a position and posture of the calibration jig 30 is measurable by the position and posture measurement unit 31 and the position and posture is uniquely determined with respect to the gripping structures 100 and 200 of the first claw portion 10 and the second claw portion 20; the first coordinate system calibration unit 18 that obtains the first conversion matrix 180 based on a result obtained by simultaneously measuring the position and posture of the calibration jig 30 fixed to the first claw portion 10, the position and posture of the first end effector 1, and the force and torque output from the first force sensor 11, the first conversion matrix 180 being for converting measured values of the position and posture of the first end effector 1 and the force and torque of the first force sensor 11 into data expressed by a reference coordinate system defined in association with the gripping structure 100; and the second coordinate system calibration unit 28 that obtains the second conversion matrix 280 based on a result obtained by simultaneously measuring the position and posture of the calibration jig 30 fixed to the second claw portion 20, the position and posture of the second end effector 2, and the force and torque output from the second force sensor 21, the second conversion matrix 280 being for converting measured values of the position and posture of the second end effector 2 and the force and torque of the second force sensor 21 into data expressed by the reference coordinate system defined in association with the gripping structure 200. The teaching data generation unit 25 converts, based on the first conversion matrix 180, the measured values of the position and posture of the first end effector 1 and the force and torque of the first force sensor 11 into the teaching data 24, which is expressed by the reference coordinate system, of the position and posture and the force and torque. The robot control unit 23 converts, based on the second conversion matrix 280, the measured values of the position and posture of the second end effector 2 and the force and torque of the second force sensor 21 into data, which is expressed by the reference coordinate system, of the position and posture and the force and torque, and causes the data to follow the position and posture and/or the force and torque in the teaching data 24.

In addition, in the robot teaching device 5 according to the embodiment, each of the first conversion matrix 180 and the second conversion matrix 280 includes a position conversion matrix for converting a position and posture and a force conversion matrix for converting a force and torque, and the first coordinate system calibration unit 18 and the second coordinate system calibration unit 28 each calculate the force conversion matrix based on data of a force and torque (calibration jig force-torque data 300) applied to the calibration jig 30.

In addition, the robot teaching device 5 according to the embodiment calculates the force and torque (the calibration jig force-torque data 300) applied to the calibration jig 30 based on a weight of the calibration jig 30 and a position of a gravity center of the calibration jig 30 as viewed from the reference coordinate system (first embodiment).

In the robot teaching device 5 according to the embodiment, the calibration jig 30 includes the third force sensor 35 that measures the force and torque (calibration jig force-torque data 300) applied to the calibration jig 30 (second embodiment).

The robot teaching device 5 according to the embodiment includes the reference coordinate system setting unit 40 that sets the reference coordinate system, and the impedance characteristic setting unit 41 that sets a target impedance characteristic for a difference between the position and posture of the teaching data 24 and the position and posture of the second end effector 2 expressed by the reference coordinate system.

According to the embodiment, the first end effector 1 that can be intuitively operated by the teacher can be implemented by the configuration of the first claw portion 10 in the openable and closable state and the handle 12. It is possible to provide the robot teaching device 5 that can accurately measure an interaction force between the first end effector 1 and a work object by using the output of the first force sensor 11 when the first claw portion 10 is in the opening-closing fixing state and the teacher grips only the handle 12.

The invention is not limited to the embodiments described above, and includes various modifications. For example, the embodiments described above have been described in detail to facilitate understanding of the invention, and the invention is not necessarily limited to those including all the configurations described above. A part of a configuration of a certain embodiment can be replaced with a configuration of another embodiment, and the configuration of another embodiment can be added to a configuration of a certain embodiment. A part of a configuration of each embodiment may be added to, deleted from, or replaced with another configuration.

A part or all of the configurations, functions, processing units, processing methods, or the like described above may be implemented by hardware by, for example, designing with an integrated circuit. The above configurations, functions, or the like may be implemented by software by a processor interpreting and executing a program for implementing each function. Information such as a program, a table, and a file for implementing each function can be stored in a storage device such as a memory, a hard disk, or a solid state drive (SSD), or in a recording medium such as an IC card, an SD card, or a DVD.

Control lines and information lines indicate what is considered to be necessary for description, and not necessarily all control lines and information lines are always shown on a product. Actually, almost all configurations may be considered to be connected to one another.

### REFERENCE SIGNS LIST

1: first end effector
10: first claw portion
100: first claw portion gripping structure
101: first claw portion opening and closing direction
11: first force sensor
12: handle
13: opening and closing mechanism
14: opening and closing operation unit
15: opening-closing fixing mechanism
16: first to-be-measured unit
160: optical marker
17: information processing unit
18: first coordinate system calibration unit
180: first conversion matrix
19: battery
2: second end effector
20: second claw portion
200: second claw portion gripping structure
201: second claw portion opening and closing direction
21: second force sensor
22: robot
23: robot control unit
24: teaching data
25: teaching data generation unit
26: feedback data
28: second coordinate system calibration unit
280: second conversion matrix
30: calibration jig
31: position and posture measurement unit
32: teacher
33: calibration jig gravity center
34: calibration jig gravity
35: third force sensor
36: to-be-gripped structure
37: third to-be-measured unit
370: optical marker
40: reference coordinate system setting unit
41: impedance characteristic setting unit
5: robot teaching device
ΣC: calibration jig coordinate system
ΣE1: first end effector coordinate system
ΣF1: first force sensor coordinate system
ΣF3: third force sensor coordinate system
ΣT: reference coordinate system

1. A robot teaching device comprising:
a first end effector gripped and operated by a teacher;
a second end effector connected to a robot; and
a teaching data generation unit configured to generate teaching data for teaching the robot an operation of the second end effector based on an operation of the first end effector, wherein
the first end effector includes
a first claw portion that is switchable, by an operation of the teacher, between an openable and closable state in which the first claw portion is openable and closable and an opening-closing fixing state in which the first claw portion is not openable and closable,
a handle that is capable of gripping by the teacher, and
a first force sensor that is disposed between the first claw portion and the handle and that is capable of measuring at least one of a force or a torque acting between the first claw portion and the handle, and
the teaching data generation unit generates the teaching data based on an output of the first force sensor when the first claw portion is in the opening-closing fixing state and the handle is gripped by the teacher.

2. The robot teaching device according to claim 1, further comprising:
a second force sensor disposed between the robot and the second end effector and capable of measuring at least one of a force or a torque acting between the robot and the second end effector;
a position and posture measurement unit configured to measure at least one of a position or a posture of the first end effector; and
a robot control unit configured to control the robot, based on the teaching data generated by the teaching data generation unit based on an output of the position and posture measurement unit and the output of the first force sensor and based on at least one of a position or a posture of the second end effector and an output of the second force sensor, wherein
the second end effector includes a second claw portion that is opened and closed by a power from the robot and that has a gripping structure at least partially same as a gripping structure of the first claw portion.

3. The robot teaching device according to claim 2, further comprising:
a calibration jig fixed such that at least one of a position or a posture of the calibration jig is measurable by the position and posture measurement unit and at least one of the position or the posture is uniquely determined with respect to the gripping structures of the first claw portion and the second claw portion;
a first coordinate system calibration unit configured to obtain a first conversion matrix based on a result obtained by simultaneously measuring at least one of the position or the posture of the calibration jig fixed to the first claw portion, at least one of the position or the posture of the first end effector, and at least one of the force or the torque output from the first force sensor, the first conversion matrix being for converting measured values of at least one of the position or the posture of the first end effector and at least one of the force or the torque of the first force sensor into data expressed by a reference coordinate system defined in association with the gripping structure; and
a second coordinate system calibration unit configured to obtain a second conversion matrix based on a result obtained by simultaneously measuring at least one of the position or the posture of the calibration jig fixed to the second claw portion, at least one of the position or the posture of the second end effector, and at least one of the force or the torque output from the second force sensor, the second conversion matrix being for converting measured values of at least one of the position or the posture of the second end effector and at least one of the force or the torque of the second force sensor into data expressed by the reference coordinate system defined in association with the gripping structure, wherein
the teaching data generation unit converts, based on the first conversion matrix, the measured values of at least one of the position or the posture of the first end effector and at least one of the force or the torque of the first force sensor into teaching data, which is expressed by the reference coordinate system, of at least one of the position or the posture and at least one of the force or the torque, and
the robot control unit converts, based on the second conversion matrix, the measured values of at least one of the position or the posture of the second end effector and at least one of the force or the torque of the second force sensor into data, which is expressed by the reference coordinate system, of at least one of the position or the posture and at least one of the force or the torque, and causes the data to follow at least one of the position or the posture and/or at least one of the force or the torque in the teaching data.

4. The robot teaching device according to claim 3, wherein
each of the first conversion matrix and the second conversion matrix includes
a position conversion matrix for converting at least one of a position or a posture, and
a force conversion matrix for converting at least one of a force or a torque, and
the first coordinate system calibration unit and the second coordinate system calibration unit each calculate the force conversion matrix based on data of at least one of a force or a torque applied to the calibration jig.

5. The robot teaching device according to claim 4, wherein
at least one of the force or the torque applied to the calibration jig is calculated based on a weight of the calibration jig and a position of a gravity center of the calibration jig as viewed from the reference coordinate system.

6. The robot teaching device according to claim 4, wherein
the calibration jig includes a third force sensor that measures at least one of the force or the torque applied to the calibration jig.

7. The robot teaching device according to claim 3, further comprising:
a reference coordinate system setting unit configured to set the reference coordinate system; and
an impedance characteristic setting unit configured to set a target impedance characteristic for a difference between at least one of the position or the posture in the teaching data and at least one of the position or the posture of the second end effector expressed by the reference coordinate system.

8. The robot teaching device according to claim 1, wherein
the first end effector includes
an information processing unit configured to acquire a measured value of the first force sensor and transmit the measured value to an external device by wireless communication, and
a battery configured to supply a power to the first force sensor and the information processing unit.

9. The robot teaching device according to claim 1, wherein
the first end effector includes
an opening and closing mechanism configured to open and close the first claw portion,
an opening and closing operation unit configured to perform an opening and closing operation of the opening and closing mechanism of the first claw portion, and
an opening-closing fixing mechanism configured to fix an opening and closing state of the opening and closing mechanism of the first claw portion, and
the openable and closable state and the opening-closing fixing state of the first claw portion are switched by the opening-closing fixing mechanism.
